(19) United States
(12) Patent Application Publication
(10) Pub. No.: US 2007/0014563 A1
(43) Pub. Date: Jan. 18, 2007

(54) Ring-shaped Luminaire

(75) Inventor: Daniel Ferro, Basel (CH)

Correspondence Address: GUDRUN E. HUCKETT DRAUDT, LONSSTR. 53, WUPPERTAL, 42289, DE

(73) Assignee: BRON ELEKTRONIK AG, Allschwil (CH)

(21) Appl. No.: 11/457,462

(22) Filed: Jul. 14, 2006

(30) Foreign Application Priority Data
Jul. 14, 2005 (DE) 10 2005 034 436.4

(51) Int. Cl. G03B 15/06

(52) U.S. Cl. 396/199

(57) ABSTRACT

A ring-shaped luminaire has a luminaire housing with an opening for a camera lens. At least one illumination element is arranged inside the luminaire housing behind a light passage of the luminaire housing. An attachment is arranged on the luminaire housing. The attachment has at least one honeycomb louver that is positioned in front of the light passage. The attachment has an opening for the camera lens.

### BACKGROUND OF THE INVENTION

The invention relates to a ring-shaped luminaire comprising a luminaire housing that has an opening for a camera lens and in which at least one illumination element is arranged and positioned behind a light passage.

For a shadow-free illumination for taking photographic images, ring-shaped light sources are known which are mounted on the camera lens and surround it annularly. Such ring-shaped luminaires illuminate the object to be photographed precisely from the point from where the image is being taken so that all hard shadows are within the area that is outside the viewing range of the camera lens. Since the light exiting through the light passage however radiates more or less at a wide angle, a precise light guiding action is not possible. Especially in professional photography, this is a disadvantage, for example, when only a portion of the area to be photographed is to be illuminated by the ring-shaped luminaire.

### SUMMARY OF THE INVENTION

The invention has the object to configure a ring-shaped luminaire of the aforementioned kind such that it enables a light guiding action.

This object is solved for a ring-shaped luminaire in accordance with the invention in that at least one honeycomb structure or louver of an attachment is positioned in front of the light passage and the attachment has an opening for the camera lens.

In the ring-shaped luminaire according to the invention, the honeycomb structure (louver) of the attachment in front of the light passage ensures that the radiation angle of the exiting light is limited. In this way, a light guiding action is possible so that only a portion of the area to be photographed is illuminated by the ring-shaped luminaire. Since the attachment has a central opening, the ring-shaped luminaire with attachment can be attached to the camera lens such that the lens projects into the openings of the luminaire housing and of the attachment.

Furtherfeatures of the invention can be taken from the dependent claims, the description, and the drawings.

### BRIEF DESCRIPTION OF THE DRAWINGS

The invention will be explained in more detail with the aid of an embodiment illustrated in the drawings.

FIG. 1 shows in a perspective illustration a ring-shaped luminaire according to the invention.

FIG. 2 is an end view of the ring-shaped luminaire according to FIG. 1.

FIG. 3 is a plan view as well as a section view of the ring-shaped luminaire according to the invention.

FIG. 4 is a perspective illustration of the attachment of the ring-shaped luminaire according to the invention.

### DESCRIPTION OF PREFERRED EMBODIMENTS

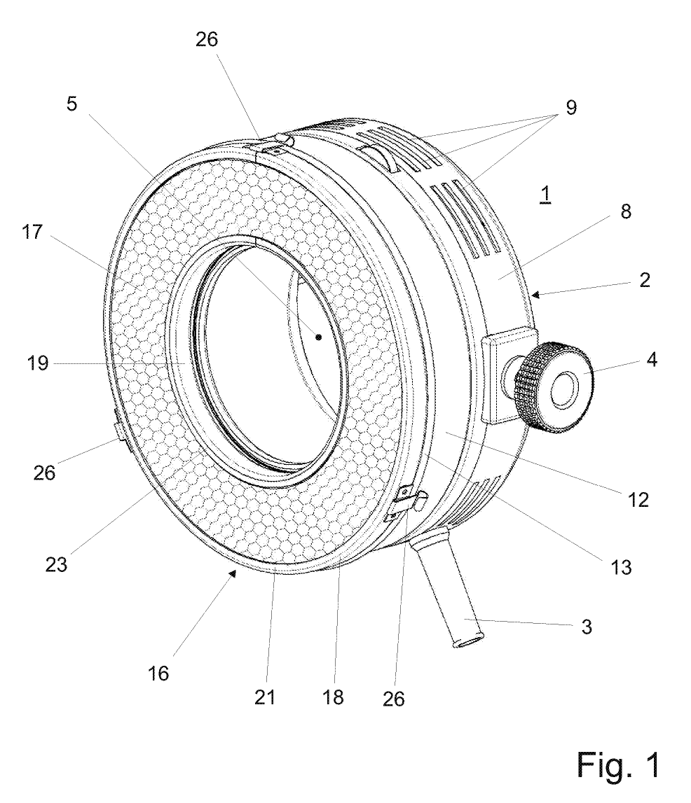

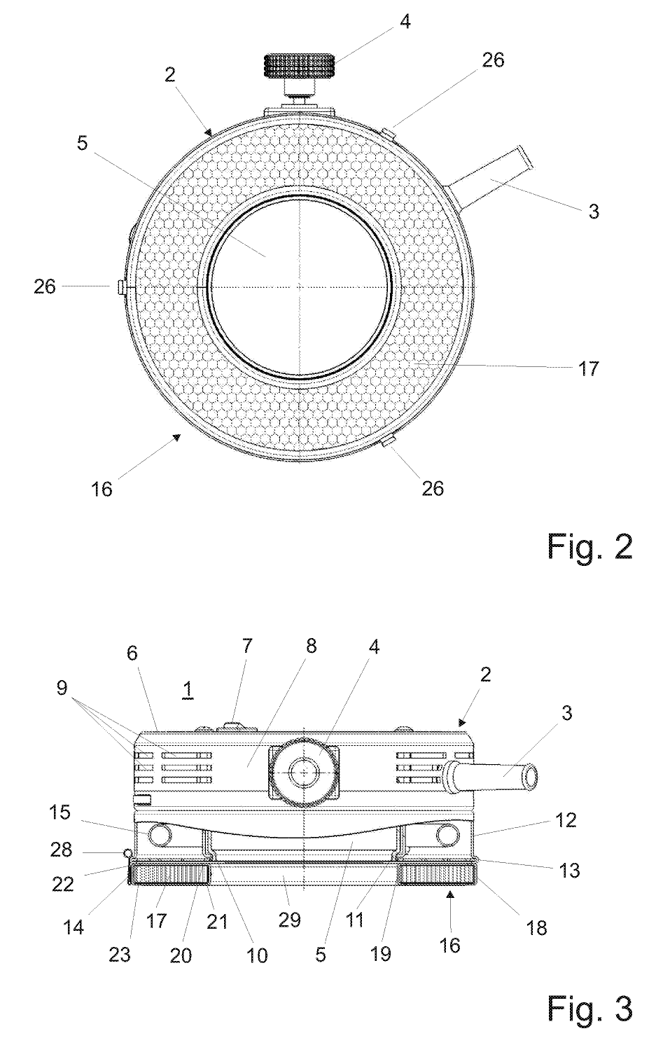

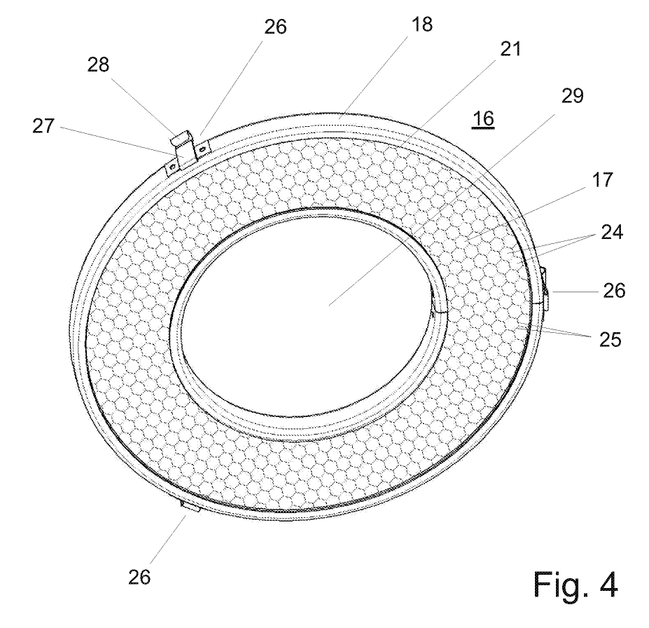

The ring-shaped luminaire 1 illustrated in FIGS. 1 to 4 serves for a shadow-free illumination for taking photographic images. The ring-shaped luminaire is placed onto the camera lens such that it annularly surrounds the camera lens. By means of the ring-shaped luminaire 1, the object to be photographed is precisely illuminated from the point from where the image is to be taken so that hard shadows will occur only within the area that is not viewed by the camera lens. The ring-shaped luminaire 1 is advantageously used in microscope photography as well as in professional portrait photography or fashion photography. In particular for portrait photography and fashion photography, the ring-shaped luminaire 1 is provided with a flash tube.

The ring-shaped luminaire 1 has a ring-shaped luminaire housing 2 provided with a connector for a connecting line (not illustrated) and a clamping screw 4. The luminaire housing 2 has a central circular opening 5 through which the camera lens (not illustrated) projects when the luminaire is mounted on the camera. On the back 6 of the luminaire housing 2 a switch 7 (FIG. 3) is provided with which the ring-shaped luminaire 1 can be switched on.

The luminaire housing 2 has a cylindrical wall 8 provided with venting slots 9 distributed about the circumference.

The opening 5 is delimited by a cylindrical inner wall 10 having a free end 11 that is radially inwardly stepped. The luminaire housing 2 is also provided with a cylindrical outer wall 12 having a free end that is U-shaped when viewed in axial section. This profiled end 13 of the outer wall 12 forms a circumferential flange with which the radial outer edge of the annular transparent pane 14 is engaged. Behind the transparent pane 14 in the area between the inner and outer walls 10, 12 a ring-shaped tube flash 15 is arranged. The transparent pane 14 forms a light passage of the ring-shaped luminaire 1. The transparent pane 14 extends between the inner and the outer walls 10, 12.

The circumferential outwardly curved rim 13 of the outer wall 12 serves not only for securing the transparent pane 14 but also for securing an attachment 16 provided with a honeycomb structure 17. The attachment 16 has an outer ring 18 and an inner ring 19 that are U-shaped in cross-section. Both rings 18, 19 are coaxial to one another and engage with their oppositely oriented legs 20, 21; 22, 23 the honeycomb structure 17 positioned between them at its inner and outer sides. The two rings 18, 19 are positioned at the level of the inner wall 10 and the outer wall 12 of the luminaire housing 2. The radial width of the honeycomb structure 17 corresponds approximately to the radial width of the transparent pane 14.

In the illustrated embodiment, the honeycomb structure 17 is comprised of hexagon honeycombs 24 that are delimited by webs 25. The honeycombs 24 extend uniformly about the entire circumference and the entire radial width of the honeycomb structure 17. All honeycombs 24 have the same size. The webs 25 have a height that corresponds to the spacing of the legs 20, 21; 22, 23 of the rings 18, 19.

The attachment 16 is detachably attached to the luminaire housing 2. For this purpose, the attachment 16 in the illustrated embodiment is provided with three locking or snap-on elements 26 that have the same angular spacing relative to one another and with which the attachment 16 is connectable in a releasable way to the outer wall 12 of the luminaire housing 2. The locking/snap-on elements 26 are identical and attached to the outer side of the outer ring 18. The element 26 has a spring stay 27 that projects past the outer ring 18 approximately axially and has a free end that is bent to a roll 28. The roll projects past the spring stay 27 radially and axially. The spring stay 27 is directed in the axial direction at a slant inwardly so that the roll 28 is positioned approximately at the level of the leg 22 of the outer ring 18. When the attachment is connected to the end face of the luminaire housing 2, the rolls 28 of the locking/snap-on elements 26 reach the circumferentially extending and radially projecting rim 13 of the outer wall 12 of the luminaire housing 2. Upon pushing the attachment farther, the spring stays 27 are caused to be bent radially outwardly until the rolls 28 engage from behind the circumferential rim 13 (FIG. 3). The attachment 16 is securely connected to the luminaire housing 2. The pretension of the spring stays 27 is so great that a safe securing action of the attachment 16 on the luminaire housing 2 or its outer wall 12 is ensured. As a result of the cylindrical configuration of the roll 28, the attachment 16 can be simply connected to the luminaire housing 2. Likewise, it is possible to remove the attachment 16 easily, as needed, from the luminaire housing 2. Since the circumferential rim 13 of the outer wall 12 of the luminaire housing 2 is also configured to be curved, the attachment 16 can be simply connected and removed. Because the rim 13 extends about the circumference, it is not necessary to provide exact alignment relative to the luminaire housing 2 when connecting the attachment 16.

The attachment 16 has also a central opening 29 which is delimited by the inner ring 19. The opening 29 has the same diameter as the opening 5 of the luminaire housing 2. When the luminaire housing 2 with the attachment 16 connected thereto is placed onto the camera lens, the viewing field for the camera lens remains free because of the opening 29 of the attachment 16.

Because of the honeycomb structure 17, the light passing through the transparent pane 14 is allowed to pass only at a certain radiation angle. The radiation angle depends on the height of the webs 25 and/or the diameter of the honeycombs 24. For different photographic situations, attachments 16 with differently designed honeycomb structures 17 can be used. The different attachments 16 can be connected without problem onto the luminaire housing 2 so that the photographer has an optimal attachment 16 available for different photography situations.

Advantageously, the ring-shaped luminaire can be arranged pivotably on the camera so that the ring-shaped luminaire 1 can be pivoted about a certain pivot angle relative to the camera. The pivot axis is determined by the axis of the clamping screw 4. After loosening the screw 4, the ring-shaped luminaire 1 can be pivoted by the desired angle relative to the camera lens. The illuminated area can therefore be varied relative to the axis of the lens within certain limits. By means of the attachment 16 with the honeycomb structure 17, despite the use of a ring-shaped luminaire, a precise light guiding action is possible. For example, only a portion of the area to be photographed can be illuminated by the ring-shaped luminaire 1 by connecting an attachment 16 with an appropriate honeycomb structure 17 to the luminaire housing 2.

The honeycomb structure 17 can be designed differently. For example, the honeycombs 24 must not have a hexagon shape as in the illustrated embodiment. They can have other contours that fulfill the purpose. The honeycomb structure 17 can be made of metal but also of plastic material. At least the outer ring 18 is comprised advantageously of metal material so that the attachment 16 has a sufficient strength; this is advantageous in particular for mounting.

In order to enable the described pivoting of the ring-shaped luminaire 1 relative to the camera, the diameter of the openings 5, 29 of the ring-shaped luminaire 1 is greater than the outer diameter of the camera lens.

The specification incorporates by reference the entire disclosure of German priority document 10 2005 034 436.4 having a filing date of Jul. 14, 2005.

While specific embodiments of the invention have been shown and described in detail to illustrate the inventive principles, it will be understood that the invention may be embodied otherwise without departing from such principles.

What is claimed is:

1. A ring-shaped luminaire comprising:
a luminaire housing that has an opening for a camera lens;
at least one illumination element arranged inside the luminaire housing behind a light passage of the luminaire housing;
an attachment arranged on the luminaire housing;
the attachment having at least one honeycomb louver that is positioned in front of the light passage; and
the attachment having an opening for a camera lens.

2. The ring-shaped luminaire according to claim 1, wherein the opening of the attachment is coaxial to the opening of the luminaire housing.

3. The ring-shaped luminaire according to claim 1, wherein the attachment is ring-shaped.

4. The ring-shaped luminaire according to claim 1, wherein the at least one honeycomb louver has honeycombs of identical size.

5. The ring-shaped luminaire according to claim 4, wherein the honeycombs are delimited by webs.

6. The ring-shaped luminaire according to claim 5, wherein a height of the webs matches approximately a thickness of the attachment.

7. The ring-shaped luminaire according to claim 1, wherein the attachment has two rings framing the at least one honeycomb louver.

8. The ring-shaped luminaire according to claim 7, wherein one of the two rings is a radial inner ring delimiting the opening of the attachment.

9. The ring-shaped luminaire according to claim 1, wherein a radial width of the at least one honeycomb louver matches approximately a radial width of the light passage.

10. The ring-shaped luminaire according to claim 1, wherein the attachment is detachably connected to the luminaire housing.

11. The ring-shaped luminaire according to claim 10, wherein the attachment has at least one locking/snap-on element.

12. The ring-shaped luminaire according to claim 11, wherein the at least one locking/snap-on element has a spring stay that is prestressed when the attachment is in a mounted position on the luminaire housing.

13. The ring-shaped luminaire according to claim 11, wherein the at least one locking/snap-on element engages from behind at least one positive locking element of the luminaire housing.

14. The ring-shaped luminaire according to claim 13, wherein the at least one positive locking element extends in a ring shape.

15. The ring-shaped luminaire according to claim 13, wherein the at least one positive looking element is a shaped edge of an outer wall of the luminaire housing.

16. The ring-shaped luminaire according to claim 1, configured to be pivotable relative to the camera lens.
